(19) United States
(12) Patent Application Publication
(10) Pub. No.: US 2024/0384824 A1
(43) Pub. Date: Nov. 21, 2024

(54) DEVICE FOR SEWAGE PIPE WORK

(71) Applicant: Rausch Rehab GmbH, Immenstadt i. Allgäu (DE)

(72) Inventors: Heiko BUHMANN, Buchenberg (DE); Tim NIEDING, Immenstadt (DE)

(21) Appl. No.: 18/692,291

(22) PCT Filed: Sep. 14, 2022
(86) PCT No.: PCT/EP2022/075491

§ 371 Date: Mar. 14, 2024

(30) Foreign Application Priority Data
Sep. 15, 2021 (DE) 10 2021 004 677.3

(51) Int. Cl. F16L 55/40; F16L 101/10; F16L 101/30

(52) U.S. Cl. CPC F16L 55/40; F16L 2101/10; F16L 2101/30

(57) ABSTRACT

The invention relates to a device (1) for sewage pipe work, comprising: —a base unit (2), which can be moved in a sewage pipe; —a rotary head (3), which is disposed on the base unit (2) and can be rotated about an axis of rotation (A) associated with the rotary head (3); —a first lifting arm (4), which is rotatably mounted on the rotary head (3); —a holding portion (5), which is rotatably mounted on the first lifting arm (4) and is designed to hold a working device (6); —a first actuator (7) for moving the holding portion (5), the first actuator being mounted on the rotary head (3); —a working circuit, which is associated with the first actuator (7); and —a line, which can be connected to the working device (6); wherein the working circuit associated with the first actuator (7) extends within the device (1) from the interior of the base unit (3) to the interior of the first actuator (7), and wherein the line which can be connected to the working device (6) extends within the device (1) from the interior of the base unit (2) to the interior of the holding portion (5).

The present invention relates to a device for sewer pipe work, in particular for sewer pipe rehabilitation and sewer pipe inspection work.

Remote-controlled devices for sewer pipe work, known as sewer robots, are used for trenchless rehabilitation and inspection of water and wastewater pipes or other pipelines, for example.

Such devices typically comprise a base unit on which a rotary head rotatable about an axis of rotation is arranged. Two rotatably mounted lifting arms extending parallel to each other and connected to a working device, such as a milling head, are usually arranged on the rotary head. The two lifting arms are usually movable via an actuator, for example a hydraulic cylinder. In addition, the working device is rotatably mounted on the lifting arms. Accordingly, such devices can have at least three joints by means of which the working device can be steered into the desired position. The devices also include a swivellable camera, by means of which water or wastewater pipes, for example, can be inspected and corresponding rehabilitation or repair work to be carried out can be monitored. Corresponding lines, in particular power supply and/or data lines, are required to operate the working device and the swivellable camera. Due to the large number of joints, these lines are designed to be exposed and are generally located either between the two lifting arms, which extend parallel to each other, or are arranged below, above or next to the lifting arms.

It has turned out to be particularly problematic that during the sewer work of the device, the exposed pipes necessary for the operation of the working device and the camera can, on the one hand, result in the device getting caught on obstacles in the pipes, such as tree roots, stones or the like, and the exposed pipes can be damaged in the worst case. On the other hand, it was found that the pipes often restrict the camera's field of view, meaning that it is not possible to monitor the sewer pipe work for all areas that can be captured by the camera.

It is therefore an object of the present invention to provide a novel device for sewer pipe work which ensures improved protection for lines of components of the device.

This object is achieved by means of a device for sewer pipe work having the features of the independent claim. Preferred embodiments and specific configurations of the device according to the invention are specified in the dependent claims.

The device for sewer pipe work, in particular for sewer pipe rehabilitation and sewer pipe inspection work, in accordance with the invention comprises a base unit movable in a pipe duct and a rotary head arranged on the base unit, which head is rotatable about an axis of rotation assigned to the rotary head. In addition, the device comprises a first lifting arm rotatably mounted on the rotary head and an accommodation portion rotatably mounted on the first lifting arm, which is configured to accommodate a working device, in particular a milling head or any other tool. Furthermore, the device comprises a first actuator mounted on the rotary head for moving the accommodation portion, a working circuit assigned to the first actuator, and a line which is connectable to the working device. According to the invention, the working circuit assigned to the first actuator extends, originating from the interior of the base unit, to the interior of the first actuator inside the device. In addition, the line connectable to the working device extends, originating from the interior of the base unit, to the interior of the accommodation portion, also inside the device.

The device according to the invention makes it possible that obstacles located in sewer pipelines can be rehabilitated or repaired in an advantageous manner, for example tree roots or larger debris such as stones or the like, do not cause the device to become entangled in these obstacles due to the line connectable to the working device or exposed outer sections of the working circuit assigned to the first actuator, or the line or the working circuit to be damaged. Rather, only the outer surfaces of the device, which are more robust than the line connectable to the working device, can come into contact with obstacles in the pipeline, whereas the line connectable to the working device or the working circuit of the first actuator remains protected.

In the context of the present invention, the wording “that a line of the device connectable to or associated to a component of the device extends inside the device” means that this line is enclosed by the device from at least three coordinate directions, preferably from all four coordinate directions, along its extension direction starting from the interior of the base unit to the interior of the component in each line cross-section perpendicular to the extension direction in a Cartesian coordinate system connected to the line cross-section, the zero point of which is located at the center of the cross-section of the line. The same applies to a working circuit assigned to an actuator of the device. In other words, for example, if the line connectable to the working device extends at least partially along the first lifting arm, the first lifting arm can be designed in a partial area, for example, such that the line cross-section (an X-Y intersection) of said line is enclosed by side surfaces of the first lifting arm of the device, for example at least in the positive and negative X-direction (from the left and right) and in the positive Y-direction (from above). However, the first lifting arm can preferably also be designed in a partial area in such a way that the line cross-section of said line is enclosed by side surfaces of the first lifting arm in the positive and negative X and Y directions (from the left, right, top and bottom). In order to ensure the greatest possible protection for said line, the line is preferably entirely enclosed by the device, starting from the inside of the base unit to the inside of the corresponding component. As already mentioned, the same applies to a working circuit assigned to an actuator of the device.

In general, the device according to the invention may in each case have a rotary union in articulation areas, i.e. in areas in which two mutually-coupled components of the device are movable relative to one another. The respective rotary union can be configured in such a way that one of the two components is rotatably mounted on the other component and at the same time the line extending between the two components and/or the working circuit extending between the two components is accommodated and/or the rotary union forms a subsection of the line extending between the two components and/or of the working circuit. For this purpose, the rotary union can be designed as a cylindrical hollow body and have one or more recesses along its outer circumferential surface, at least in sections. In the case of a line extending between the components, the rotary union can be designed with slip rings to realize larger angles of rotation of the rotatably mounted component.

According to a preferred embodiment, the first actuator may be a first hydraulic cylinder and the working circuit assigned to the first actuator may be a hydraulic circuit. The hydraulic circuit assigned to the first hydraulic cylinder, which extends from the interior of the base unit to the interior of the first hydraulic cylinder inside the device, may comprise a hydraulic fluid tank, a hydraulic pump and one or more hydraulic valves, each of which is preferably arranged inside the base unit.

The hydraulic circuit assigned to the first hydraulic cylinder can extend from the interior of the base unit via the rotary head to the interior of the first hydraulic cylinder rotatably mounted on the rotary head, i.e. inside the device. For this purpose, the device according to the invention can be designed with a rotary union in the articulation areas between the base unit and the rotary head and between the rotary head and the first hydraulic cylinder, which is configured to transport hydraulic fluid of the hydraulic circuit assigned to the first hydraulic cylinder.

This makes it possible that only the robust outer surfaces of the device according to the invention can come into contact with obstacles in the sewer pipelines to be rehabilitated or repaired, such as tree roots or stones, and the hydraulic circuit assigned to the first hydraulic cylinder is protected from damage. In addition, the device according to the invention prevents the device from getting caught on obstacles located in the sewer pipelines by external hoses of the hydraulic circuit assigned to the first hydraulic cylinder.

Preferably, the device according to the invention may also comprise a second actuator which is rotatably mounted on the rotary head and which is configured to move the accommodation portion. In this context, the device can also have a working circuit assigned to the second actuator, which extends from the interior of the base unit to the interior of the second actuator inside the device.

According to a preferred configuration, the second actuator can be a second hydraulic cylinder and the working circuit assigned to the second actuator can be a hydraulic circuit.

In order to move the first lifting arm, the first actuator can be connected to the first lifting arm via a support section, for example. On the other hand, the second actuator can be connected to the accommodation portion, which is rotatably mounted on the first lifting arm, in order to move the accommodation portion and thus the working device that can be accommodated on the accommodation portion, for example a corresponding motor including a milling head. The working circuit assigned to the second actuator can be of similar design as the circuit assigned to the first actuator. This applies in particular if the above-mentioned actuators are each designed as hydraulic cylinders.

In general, the working circuit assigned to the second actuator can extend from the interior of the base unit via the rotary head to the interior of the second actuator rotatably mounted on the rotary head, i.e. inside the device. For this purpose, the device according to the invention can in each case be designed with a rotary union in the articulation areas between the base unit and the rotary head and between the rotary head and the second actuator, which union is configured to form a subsection of the working circuit assigned to the second actuator.

If the second actuator is designed as a second hydraulic cylinder, the hydraulic circuit assigned to the second hydraulic cylinder can extend from the interior of the base unit via the rotary head to the interior of the second hydraulic cylinder rotatably mounted on the rotary head, i.e. inside the device. For this purpose, the device according to the invention can be designed in the articulation areas between the base unit and the rotary head and between the rotary head and the second hydraulic cylinder in each case with a rotary union which is configured to transport hydraulic fluid of the second hydraulic circuit.

This makes it possible that only the robust outer surfaces of the device according to the invention can come into contact with obstacles in the sewer pipelines to be rehabilitated or repaired, such as tree roots or stones, and the hydraulic circuit assigned to the second hydraulic cylinder is protected from damage. In addition, the device according to the invention prevents the device from getting caught on obstacles located in the sewer pipelines by external hoses of the hydraulic circuit assigned to the second hydraulic cylinder.

More precisely, a first rotary union assigned to the rotary head can preferably be arranged inside the base unit, which union forms a subsection of the hydraulic circuit assigned to the first hydraulic cylinder. For this purpose, the first rotary union can be arranged in a transition area between the rotary head and the base unit, corresponding to the axis of rotation of the rotary head. The first rotary union can be connected downstream of a hydraulic valve of the hydraulic circuit assigned to the first hydraulic cylinder. The first rotary union can additionally have a cylindrical inner section and a cylindrical outer section, each of which extends along the axis of rotation of the rotary head. The cylindrical inner section of the first rotary union can be configured to be static. In this case, the cylindrical outer section is rotatable around the axis of rotation of the rotary head. A correspondingly inverted design with a rotatable cylindrical inner section and static cylindrical outer section is also conceivable. The cylindrical inner section and/or the cylindrical outer section can have one or more recesses along their circumferential surface, which are configured to transport hydraulic fluid of the hydraulic circuit assigned to the first hydraulic cylinder. Depending on the design of the cylindrical inner section and the cylindrical outer section, the first rotary union can have bores corresponding to the one or more recesses, which are also configured to transport the hydraulic fluid of the hydraulic circuit assigned to the first hydraulic cylinder.

In this context, the first rotary union preferably additionally forms a subsection of the hydraulic circuit assigned to the second hydraulic cylinder. For this purpose, the first rotary union can comprise one or more further recesses in the cylindrical inner section and/or the cylindrical outer section. In addition, the first rotary union can have one or more bores corresponding to the one or more further recesses, so that hydraulic fluid of the hydraulic circuit assigned to the second hydraulic cylinder can be transported inside the first rotary union.

Such a configuration makes it possible to dispense with conventionally used external hydraulic hoses associated to the hydraulic cylinders. This ensures that the device according to the invention does not get stuck or caught on obstacles during operation inside the sewer pipelines due to external hydraulic hoses.

The first actuator and/or the second actuator can also be designed as electrically operated actuators. In this case, the correspondingly associated working circuit can be configured as an electrical line, which extends inside the device in the same way as described above.

According to a further preferred configuration, the device can comprise a second lifting arm which is rotatably mounted on the rotary head and on which the accommodation portion is rotatably mounted. In addition, the device according to the invention can have a camera holding device arranged on the first lifting arm and/or the second lifting arm, and configured to accommodate a camera. In this context, the device can also have a line assigned to the camera, which line extends from the interior of the base unit to the interior of the chamber accommodation device inside the device.

The second lifting arm can be connected to the first lifting arm via the support section. Furthermore, the second lifting arm can be configured to additionally rotatably support the accommodation portion. The camera accommodation device, which is preferably arranged on both lifting arms, can have a bayonet mount by means of which the camera can be mounted on the camera accommodation device. Advantageously, the camera is configured as a swivel camera so that larger areas can be captured by the camera during sewer work on the device. The line assigned to the camera can be configured, for example, as a power supply line and/or data transmission line. The line assigned to the camera can extend from the inside of the base unit via the rotary head and the first lifting arm or the second lifting arm into the camera accommodation device.

This provides the advantage that the line assigned to the camera is particularly well protected and only the outer surfaces of components of the device, which are more robust than the said line, come into contact with obstacles in the sewer pipelines during sewer work. In addition, the device is prevented from getting caught on obstacles inside the sewer pipelines during operation due to external camera lines. Furthermore, the device according to the invention makes it possible to use the camera, which is preferably configured as a swivel camera, to monitor all areas that can be captured by the camera without the camera's field of view being at least partially obscured by conventionally arranged external camera lines.

The rotary head can be designed in such a way that it can be rotated continuously and/or endlessly around the axis of rotation assigned to the rotary head in relation to an angle of rotation assigned to the rotary head. For this purpose, the rotary head can, for example, comprise a rotary drive with a rotary encoder. The swivel drive can be designed in such a way that the rotary head can be rotated in the positive and negative direction of rotation.

The rotary head can also have several slip rings, which are configured to form a of subsection the line connectable to the working device and a subsection of the line assigned to the camera. In particular, the corresponding slip rings can be arranged inside the rotary head in areas adjacent to the outer circumferential surface of the rotary head. In this configuration, sections of the working circuit assigned to the first actuator and, if present, of the working circuit assigned to the second actuator can extend centrally inside the rotary head towards the first rotary union extending along the axis of rotation of the rotary head.

Advantageously, the first actuator can be mounted on the rotary head by means of a second rotary union, which union forms a subsection of the working circuit assigned to the first actuator.

If the actuators are designed as hydraulic cylinders, the first hydraulic cylinder and the second hydraulic cylinder can each comprise a plurality of bores. In particular, the two hydraulic cylinders can each have a first hydraulic cylinder bore extending essentially centrally and axially, which penetrates a rotary union accommodation portion of the corresponding hydraulic cylinder and communicates with a hydraulic fluid chamber of the corresponding hydraulic cylinder. In addition, the two hydraulic cylinders may each comprise a second hydraulic cylinder bore extending substantially perpendicular to the first hydraulic cylinder bore. Furthermore, the hydraulic cylinders can each have a decentrally arranged third hydraulic cylinder bore extending essentially parallel to the first hydraulic cylinder bore. In addition, the two hydraulic cylinders can each comprise a fourth hydraulic cylinder bore extending essentially perpendicular to the third hydraulic cylinder bore and connecting the rotary union accommodation portion. The second and fourth hydraulic cylinder bores are advantageously sealed on the outer circumferential surfaces by means of suitable sealing means.

Alternatively, instead of the respective third hydraulic cylinder bore, the corresponding hydraulic cylinder can also have a recess extending parallel to the first hydraulic cylinder bore, which is configured to accommodate a hydraulic hose connecting the third and fourth hydraulic cylinder bores. The recess can, for example, have a U-shaped cross-section. In the case of a configuration with said recess, the corresponding hydraulic hose forms a subsection of the hydraulic circuit assigned to the first or second hydraulic cylinder. In this case, said hydraulic hose extends along the recess inside the corresponding hydraulic cylinder and thus inside the device. Preferably, the respective recess can be provided with a detachable cover, so that the respective hydraulic cylinder completely encloses the accommodated hydraulic hose. This configuration provides the advantage of improved maintenance options of the hydraulic cylinders.

The hydraulic circuit assigned to the first hydraulic cylinder can be divided into a supply section and a return section. For example, the supply section can extend from the hydraulic fluid tank via a hydraulic fluid pump, a corresponding hydraulic valve, the first rotary union, the second rotary union and the first hydraulic cylinder bore of the first hydraulic cylinder into the hydraulic fluid chamber of the first hydraulic cylinder. Of course, the supply section can extend through other additional components not mentioned here. For example, the return section can extend from the second hydraulic cylinder bore, via the decentrally arranged third hydraulic cylinder bore of the first hydraulic cylinder, the fourth hydraulic cylinder bore connecting the third hydraulic cylinder bore and the rotary union accommodation portion, the second rotary union and the first rotary union into the hydraulic fluid tank. Of course, the return section can also extend through other additional components not mentioned here.

According to a further preferred configuration, the second actuator, in particular the second hydraulic cylinder, can be mounted on the rotary head by means of a third rotary union, which forms a subsection of the working circuit assigned to the second actuator. In this context, the second actuator can preferably be mounted on the rotary head along an axis of rotation common to the first actuator.

If the actuators are designed as hydraulic cylinders, the hydraulic circuit assigned to the second hydraulic cylinder can also be divided into a supply section and a return section, wherein the supply section and return section are designed similar to the supply section and return section of the hydraulic circuit assigned to the first hydraulic cylinder.

By means of the above-described configuration, it can be realized that the working circuit associated with the first actuator and, if present, the working circuit assigned to the second actuator each extend inside the device. This protects the working circuit assigned to the respective actuators from damage. In addition, during operation, the device cannot get caught or stuck on obstacles located in sewer pipelines as a result of conventional hydraulic lines or electrical lines located externally.

According to a preferred embodiment, the first lifting arm can have a longitudinal bore, which can be designed as a subsection of the line connectable to the working device. For example, the longitudinal bore can be designed as a subsection of a pneumatic line. In this case, the line connectable to the working device is configured entirely as a pneumatic line.

Alternatively, the longitudinal bore can also be designed in such a way that the line connectable to the working device can be accommodated. In this case, the longitudinal bore has a larger cross-sectional diameter than the line connectable to the working device, and the line connectable to the working device is configured as an electrical line, for example. As an alternative to the longitudinal bore, the first lifting arm can also have a U-shaped cross-section along its direction of extension. Preferably, a cover that can be attached to the first lifting arm by means of fastening means can be arranged in order to protect the line connectable to the working device from damage during operation of the device. This configuration provides particular advantages during maintenance of the lifting arms.

According to another preferred configuration of the device according to the invention, the second lifting arm can also have a longitudinal bore, which is designed to accommodate the line assigned to the camera. Alternatively, the second lifting arm can also be designed with a U-shaped cross-section along its direction of extension and optionally with a correspondingly designed, detachably fastened cover.

The accommodation portion can be rotatably mounted on the first lifting arm by means of a third mounting union. Depending on the configuration of the device according to the invention, the accommodation portion can also be mounted on the second lifting arm. The third mounting union can be configured as a hollow body and have one or more recesses. The third mounting union and the accommodation portion are preferably designed in such a way that the accommodation portion has a swivel angle range of up to 110°.

Advantageously, in particular end regions of the lifting arms are designed in such a way that lines extending inside the lifting arms, in particular the line connectable to the working device and/or the line assigned to the camera, are completely enclosed by the device. For example, a first end region of the first lifting arm, which is configured to accommodate the third mounting union, can only comprise one opening through which the line connectable to the working device can be guided into the mounting union. Likewise, a second end region of the first lifting arm opposite the first end region, which is configured to accommodate a first mounting union, can only comprise one opening through which the line connectable to the working device can be guided into the first mounting union. Similarly, the second lifting arm can be designed in an end region to accommodate a second mounting union and to guide the line assigned to the camera. In this way, the line assigned to the camera and the line connectable to the working device can be protected from damage, particularly in articulation areas.

A specific exemplary embodiment of the invention is explained in greater detail below with reference to the accompanying drawings. The drawings show in:

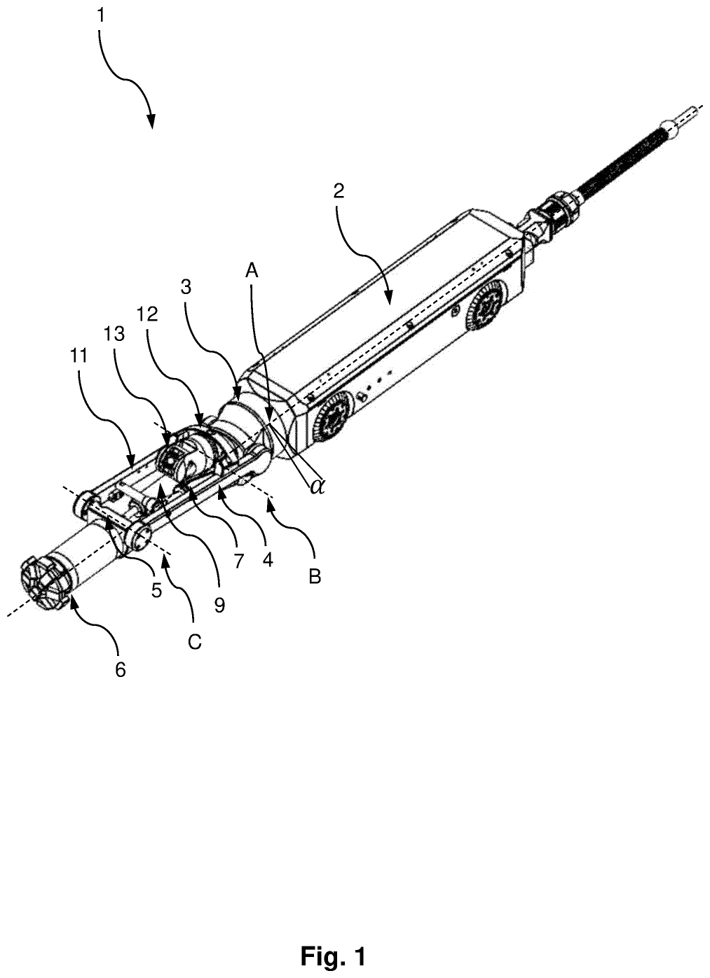

FIG. 1 a perspective view of the device for sewer pipe work according to the invention;

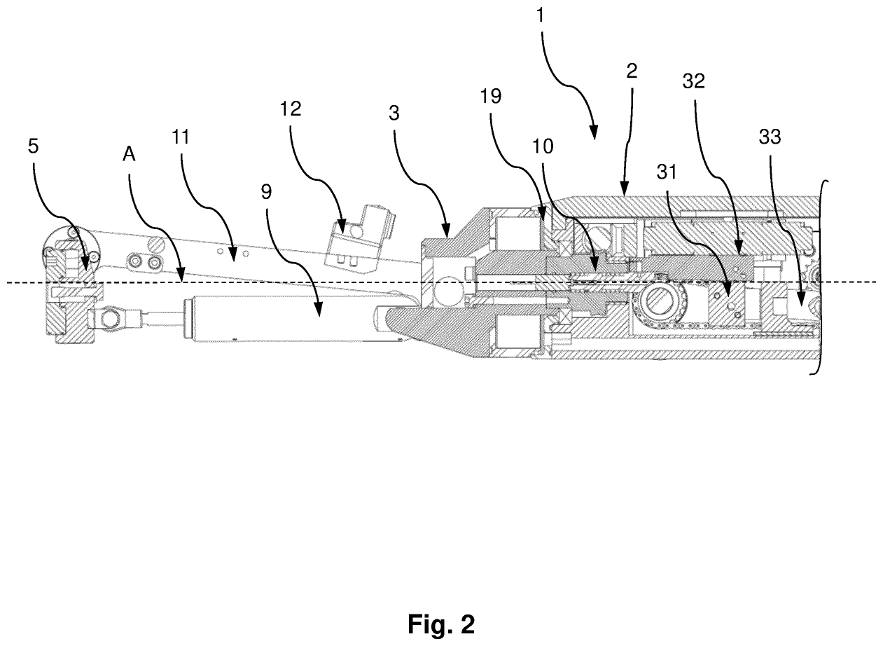

FIG. 2 a view of a longitudinal section of selected components of the device according to the invention, wherein the longitudinal section extends through an axis of rotation of a rotary head of the device;

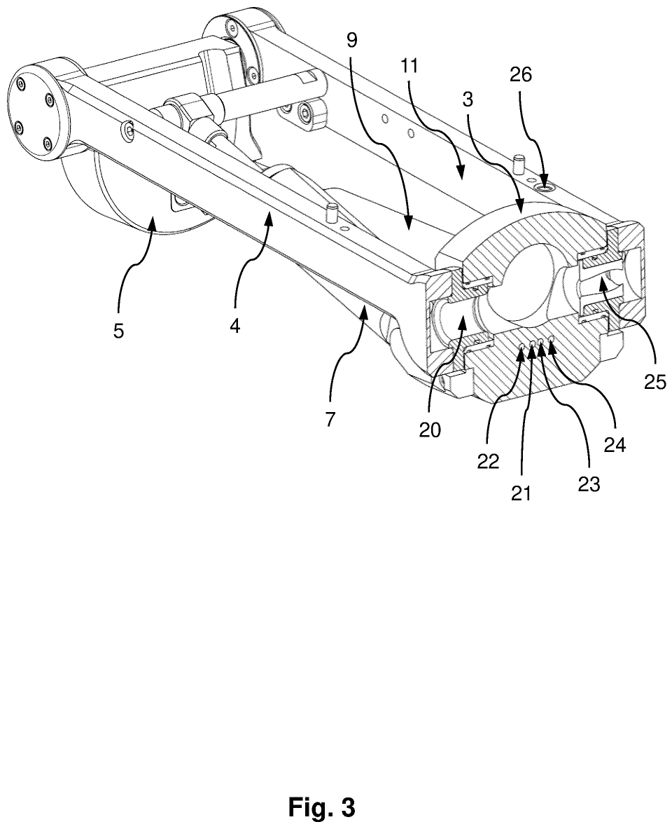

FIG. 3 a perspective view of a cross-section of selected components of the device according to the invention, wherein the cross-section extends through a mount of two lifting arms on the rotary head;

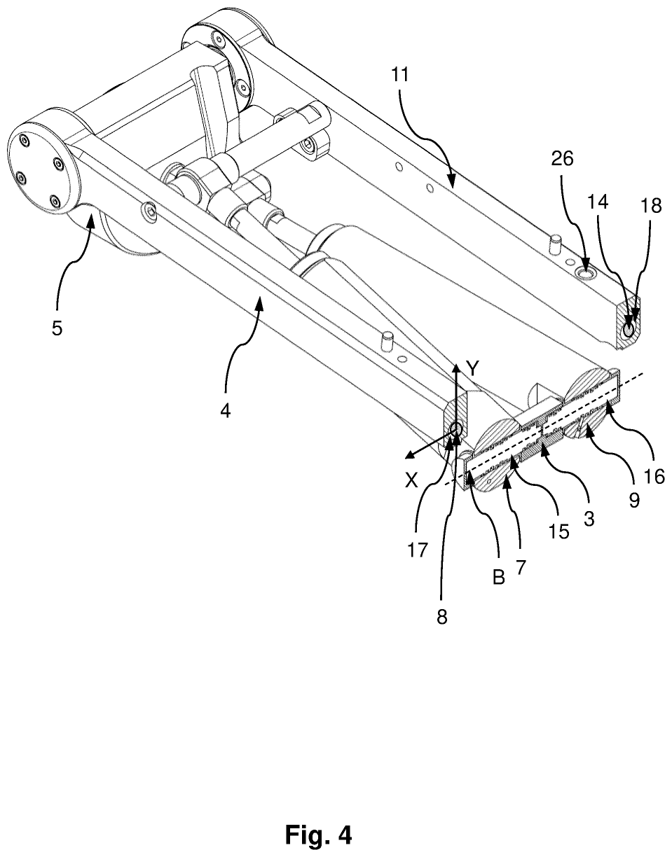

FIG. 4 a perspective view of a cross-section of selected components of the device according to the invention, wherein the cross-section extends through a mount of two hydraulic cylinders on the rotary head; and

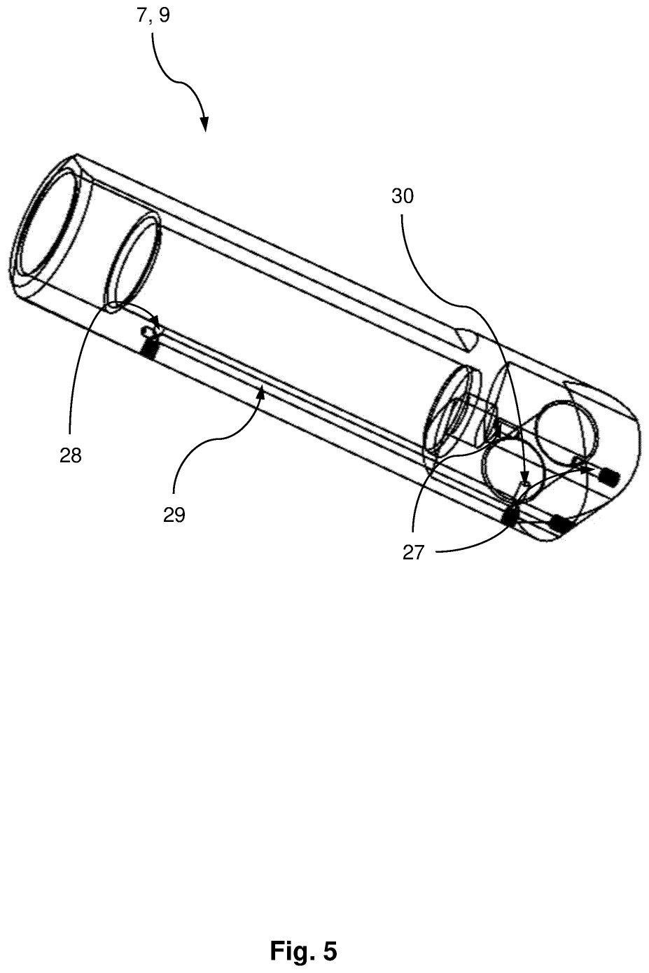

FIG. 5 a perspective view of a component of hydraulic cylinders of the device, with visible internal contour lines.

As shown in FIG. 1, the device 1 according to the invention comprises a base unit 2 and a rotary head 3 arranged on the base unit 2. The rotary head 3 can be rotated continuously and endlessly about an axis of rotation A in regards to an angle of rotation a. For this purpose, the rotary head 3 comprises an internal rotary drive, not shown, with a rotary encoder, which is configured to rotate the rotary head in positive and negative directions of rotation about the axis of rotation A. A first lifting arm 4 and a second lifting arm 11 are rotatably mounted on the rotary head. The first lifting arm 4 and the second lifting arm 11 are connected to one another via a crossbar. An accommodation portion 5 is rotatably mounted on both lifting arms 4, 11, which is configured to accommodate a working device 6. In the present case, the working device 6 comprises a milling head and an associated motor which is detachably connected to the accommodation portion 5. The working device 6 may of course also comprise other tools, in particular a drill or the like. A camera accommodation device 12 is arranged on both lifting arms 4, 11, to which device a swivel camera 13 is attached via a bayonet mount. A first actuator 7, which in the present case is a first hydraulic cylinder 7, and a second actuator 9, which in the present case is a second hydraulic cylinder 9, are mounted rotatably on the rotary head 3 about a common axis of rotation B. The first hydraulic cylinder 7 is connected to the crossbar arranged between the lifting arms 4, 11 in order to move the lifting arms 4, 11 and thus the accommodation portion 5 and the working device 6 up and down, for example in the position of the rotary head 3 shown in FIG. 1. In contrast, the second hydraulic cylinder 9 is connected to the accommodation portion 5 in order to rotate the accommodation portion 5 and thus the working device 6 in a swivel range of 110° about an axis of rotation C associated with the accommodation portion 5.

The longitudinal section of the device 1 shown in FIG. 2 shows selected components of one half of the device 1 by way of example. As can be seen from 2, a first rotary union 10 extending along the axis of rotation A is arranged inside the base unit 2, which in each case forms a subsection of a hydraulic circuit associated with the first hydraulic cylinder and the second hydraulic cylinder 9. For this purpose, the first rotary union 10 comprises a cylindrical inner section and a cylindrical outer section, which each extend along the axis of rotation A of the rotary head 3. In the present case, the cylindrical inner section of the first rotary union 10 is formed to be static. In this case, the cylindrical outer section is rotatable about the axis of rotation A of the rotary head 3. The cylindrical inner section comprises several recesses along its circumferential surface which are configured to transport hydraulic fluid of the hydraulic circuit assigned to the first hydraulic cylinder and the hydraulic circuit assigned to the second hydraulic cylinder 9. In addition, the cylindrical inner section of the first rotary union 10 comprises several bores corresponding to the recesses, which are also configured to transport hydraulic fluid of the hydraulic circuit assigned to the first hydraulic cylinder and the hydraulic circuit assigned to the second hydraulic cylinder 11. The hydraulic circuits comprise a hydraulic tank 33 formed in the type of a hose for storing the hydraulic fluid. In addition, the hydraulic circuits have a common hydraulic pump 31. In contrast, each hydraulic circuit in each case comprises a hydraulic valve 32.

As can be seen from the conjunction of FIGS. 1 to 4, a plurality of slip rings 19 are arranged inside the rotary head 3 in regions adjacent to the outer circumferential surface of the rotary head 3, which rings are configured to form a subsection of a line 8 shown in Figured 4 which can be connected to the working device 6 and a subsection of a line 14 shown in FIG. 4 which is assigned to the camera 13. This configuration of the device 1 and the arrangement of the first rotary union 10 make it possible to realize an internal routing of the hydraulic circuits assigned to the two hydraulic cylinders 7, 9, the line 8 connectable to the working device and the line 14 assigned to the camera in the transition region between the base unit 2 and the rotatable rotary head 3.

As can be taken from the conjunction of FIGS. 2 to 4, the rotary head 3 comprises a supply bore 21 and a return bore 22 of the hydraulic circuit assigned to the first hydraulic cylinder 7, which communicate with the first rotary union 10. In addition, the rotary head 3 comprises a supply bore 23 and a return bore 24 of the hydraulic circuit assigned to the second hydraulic cylinder 9, which communicate with the first rotary union 10. The supply bore 21 and the return bore 22 of the hydraulic circuit assigned to the first hydraulic cylinder 7 communicate with a second rotary union 15, which supports the first hydraulic cylinder 7 on the rotary head 3. The supply bore 23 and the return bore 24 of the hydraulic circuit assigned to the second hydraulic cylinder 9 communicate with a third rotary union 16, which supports the second hydraulic cylinder 9 on the rotary head 3.

As shown in FIG. 5, the two hydraulic cylinders 7, 9 each comprise a first hydraulic cylinder bore 27 extending substantially centrally and axially, which penetrates a rotary union accommodation portion of the corresponding hydraulic cylinder 7, 9 and communicates with a hydraulic fluid chamber of the corresponding hydraulic cylinder 7, 9. In addition, the hydraulic cylinders 7, 9 each have a second hydraulic cylinder bore 28 extending substantially perpendicular to the first hydraulic cylinder bore 27. Furthermore, the hydraulic cylinders 7, 9 each comprise a de-centrally arranged third hydraulic cylinder bore 29 extending substantially parallel to the first hydraulic cylinder bore 27. In addition, the two hydraulic cylinders 7, 9 each comprise a fourth hydraulic cylinder bore 30 extending substantially perpendicular to the third hydraulic cylinder bore 29 and connecting the rotary union accommodation portion.

As can be seen from FIGS. 2 to 5, the hydraulic circuit assigned to each of the two hydraulic cylinders 7, 9 is divided into a supply section and a return section. The respective supply section extends from the hydraulic tank 33 via the hydraulic pump 31, the corresponding hydraulic valve 32, the first rotary union 10, the corresponding supply bore 21 or 23, the second rotary union 15 or third rotary union 16, and the first hydraulic cylinder bore 27 into the hydraulic fluid chamber of the respective hydraulic cylinder 7, 9. Of course, the supply section may extend through other additional components not mentioned herein. The return section extends from the second hydraulic cylinder bore 28, via the third decentrally arranged hydraulic cylinder bore 29, the fourth hydraulic cylinder bore 30 connecting the third hydraulic cylinder bore 29 and the rotary union accommodation portion, the second rotary union 15 or the third rotary union 16, the corresponding return bore 22 or 24 and the first rotary union 10 into the hydraulic fluid tank 33. Of course, the return section can also extend through other additional components not mentioned here.

Due to this configuration, the two hydraulic circuits extend inside the device 1 and are therefore protected from damage. In addition, the field of view of the camera 13 shown in FIG. 1 is not impaired by conventionally used, external hydraulic hoses.

As can be seen from the conjunction of FIG. 1 to FIG. 4, the first lifting arm 4 is mounted on the rotary head 3 by means of a first mounting union 20 and the second lifting arm 11 by means of a second mounting union 25, wherein the two mounting unions 20 and 25 are configured to guide the line 8 connectable to the working device 6 and the line 14 assigned to the camera 13 from the rotary head 3 into the first lifting arm 4 and the second lifting arm 11. The first lifting arm 4 has a longitudinal bore 17, which accommodates the line 8 connectable to the working device 6 and leads to a third mounting union (not illustrated), by means of which the holding device 5 is mounted on the first lifting arm 4. The third mounting union is designed similar to the first mounting union 20 shown in FIG. 3. In addition, the second lifting arm 11 comprises a longitudinal bore 18 and a transverse bore 26, which together guide the line 14 associated with the camera 13. The camera accommodation device 12 shown in FIGS. 1 and 2 has a bore corresponding to the transverse bore 26, which is not shown, so that the line 14 assigned to the camera 13 can be guided into the interior of the camera accommodation device 12, where a connector plug, which is not shown, is arranged for connection to the camera 13. In the present case, the line 8, which can be connected to the working device 6, like the two hydraulic circuits and the line 14 assigned to the camera 13, extends inside the device 1 in such a way that a cross-section of the line 8 (an X-Y sectional surface) is enclosed by the device 1, from four coordinate directions, perpendicular to the direction of travel with respect to a Cartesian coordinate system connected to the cross-section of the line 8, the zero point of which is located at the center of the cross-section of the line 8.

Due to this configuration, the line 8 connectable to the working device 6 and the line 14 assigned to the camera 13 extend inside the device 1 and are thereby protected from damage. In addition, the field of view of the camera 13 shown in FIG. 1 is not impaired by external lines.

### LIST OF REFERENCE CHARACTERS

1 device for sewer pipe work
2 base unit
3 rotary head
4 first lifting arm
5 accommodation portion
6 working device
7 first hydraulic cylinder/first actuator
8 line connectable to working device
9 second hydraulic cylinder/second actuator
10 first rotary union
11 second lifting arm
12 camera accommodation device
13 camera
14 line assigned to the camera
15 second rotary union
16 third rotary union
17 longitudinal bore of the first lifting arm
18 longitudinal bore of the second lifting arm
19 slip rings
20 first mounting union
21 supply bore of first hydraulic circuit located in rotary head
22 return bore of first hydraulic circuit located in rotary head
23 supply bore of second hydraulic circuit located in rotary head
24 return bore of second hydraulic circuit located in rotary head
25 second mounting union
26 transverse bore of second lifting arm
27 first hydraulic cylinder bore
28 second hydraulic cylinder bore
29 third hydraulic cylinder bore
30 fourth hydraulic cylinder bore
31 hydraulic pump
32 hydraulic valve
33 hydraulic tank
A axis of rotation of the rotary head
B axis of rotation of the first and second hydraulic cylinders
C axis of rotation of the accommodation portion
α angle of rotation

1. A device for sewer pipe work including sewer pipe rehabilitation and sewer pipe inspection work, the device comprising:
a base unit movable in a sewer pipe;
a rotary head which is arranged on the base unit and rotatable about an axis of rotation assigned to the rotary head;
a first lifting arm rotatably mounted on the rotary head;
an accommodation portion which is rotatably mounted on the first lifting arm and configured to accommodate a working device comprising a milling cutter;
a first actuator mounted on the rotary head for moving the accommodation portion;
a working circuit assigned to the first actuator; and
a line connectable to the working device;
wherein the working circuit assigned to the first actuator extends, originating from the interior of the base unit, to the interior of the first actuator inside the device, and
wherein the line connectable to the working device extends, originating from the interior of the base unit, to the interior of the accommodation portion inside the device.

2. The device according to claim 1, further comprising:
a second actuator rotatably mounted on the rotary head, which is configured to move the accommodation portion, and
a working circuit assigned to the second actuator,
wherein the working circuit assigned to the second actuator extends, originating from the interior of the base unit, to the interior of the second actuator inside the device.

3. The device according to claim 1, wherein a first rotary union assigned to the rotary head is arranged inside the base unit and forms a subsection of the working circuit assigned to the first actuator.

4. The device according to claim 3, wherein the first rotary union additionally forms a subsection of the working circuit assigned to the second actuator.

5. The device according to claim 1, further comprising:
a second lifting arm rotatably mounted on the rotary head, on which the accommodation portion is rotatably mounted;
a camera accommodation device arranged on the first lifting arm and/or the second lifting arm, which is configured to accommodate a camera; and
a line assigned to the camera;
wherein the line assigned to the camera extends, originating from the interior of the base unit, to the interior of the chamber accommodation device inside the device.

6. The device according to claim 1, wherein the rotary head is continuously and/or endlessly rotatable about the axis of rotation (A) assigned to the rotary head with respect to an angle of rotation (α) assigned to the rotary head.

7. The device according to claim 1, wherein the first actuator is mounted on the rotary head with a second rotary union, which forms a subsection of the working circuit assigned to the first actuator.

8. The device according to claim 2, wherein the second actuator is mounted on the rotary head with a third rotary union, which forms a subsection of the working circuit assigned to the second actuator, and wherein the second actuator is mounted on the rotary head along an axis of rotation (B) common to the first actuator.

9. The device according to claim 1, wherein the first lifting arm comprises a longitudinal bore which is designed as a subsection of the line connectable to the working device or which is designed to accommodate the line connectable to the working device.

10. The device according to claim 1, wherein the second lifting arm comprises a longitudinal bore which is designed to accommodate the line assigned to the camera.

11. The device according to claim 1, wherein the first actuator is a first hydraulic cylinder and wherein the working circuit assigned to the first actuator is a hydraulic circuit, and wherein the first hydraulic cylinder comprises multiple bores which are designed to form subsections of a supply section or a return section of the hydraulic circuit assigned to the first hydraulic cylinder.

12. The device according to claim 3, wherein the second actuator is a second hydraulic cylinder, and wherein the working circuit assigned to the second actuator is a hydraulic circuit, and wherein the second hydraulic cylinder comprises multiple bores which are designed to form subsections of a supply section or a return section of the hydraulic circuit assigned to the second hydraulic cylinder.

13. The device according claim 1, wherein the rotary head comprises slip rings which are configured to form a subsection of the line connectable to the working device.

14. The device according to claim 5, wherein some of the slip rings are configured to form a subsection of the line assigned to the camera.

15. The device according to claim 1, wherein the accommodation portion is mounted on the first lifting arm with a third mounting union.
